(19) United States
(12) Patent Application Publication
(10) Pub. No.: US 2013/0087303 A1
(43) Pub. Date: Apr. 11, 2013

(54) SYSTEM AND APPARATUS FOR COOLING HIGH VOLTAGE PARTS OF A VEHICLE

(71) Applicant: Hae Kyu Lim, Bucheon (KR)

(72) Inventor: Hae Kyu Lim, Bucheon (KR)

(73) Assignees: Kia Motors Corporation, Seoul (KR); Hyundai Motor Company, Seoul (KR)

(21) Appl. No.: 13/323,714

(22) Filed: Dec. 12, 2011

(30) Foreign Application Priority Data
Oct. 5, 2011 (KR) 10-2011-0100994

(51) Int. Cl. B60H 1/32

(52) U.S. Cl. 165/41

(57) ABSTRACT

Disclosed is a system and apparatus for cooling high voltage parts of a vehicle without reducing the size or comfort of the rear seat of the vehicle. In particular, a rear seat conduit having an inlet and an outlet and a high voltage parts (HVP) conduit having a first end and a second end is provided. The rear seat conduit is disposed within a rear seat of the vehicle, and is configured to receive cooling air from an interior of the vehicle into the inlet, route the cooling air through the rear seat conduit, and out the outlet. The second end of the high voltage part conduit is configured to receive cooling air from the rear seat conduit outlet, and the first end is configured to discharge cooling air onto the HVP.

### CROSS-REFERENCE TO RELATED APPLICATION

This application claims under 35 U.S.C. §119(a) the benefit of priority of Korean Patent Application No. 10-2011-0100994, filed on Oct. 5, 2011, the entire contents of which are incorporated herein by reference.

### BACKGROUND

(a) Technical Field

The present invention relates to a system and apparatus for cooling high voltage parts of a vehicle, and more particularly, to a technology relating to an air supply structure for cooling high voltage parts such as a high voltage battery, an inverter, or the like, mounted in a vehicle, such as an electric car, a hybrid car, or the like.

(b) Background Art

High voltage parts, such as a high voltage battery, an inverter, or the like, are mounted in a hybrid car, an electric car, or the like. To function efficiently and safely, such high voltage parts should be maintained at an appropriate operating temperature. Accordingly, it is often necessary to cool such high voltage parts to ensure that they do not overheat. In order to appropriately cool such high voltage parts, the conventional art includes an opening part 504 of a suction duct 502 for introducing cool air to the high voltage part, wherein the opening part 504 is disposed on the side of a rear seat 500 of a vehicle, as shown in FIGS. 1 and 2.

Generally, high voltage parts 506 such as a high voltage battery, or the like, are mounted in the trunk of a vehicle, or some similar space. Generally, air for cooling the high voltage parts 506 is supplied from the inside of a vehicle. As shown in FIGS. 1 and 2, the opening part 504 of the suction duct 502 is disposed on the side of the rear seat 500, and supplies air from the inside of the vehicle to the high voltage parts 506 through the suction duct 502, thereby cooling the high voltage parts.

Disadvantageously, in the above-mentioned conventional art structure, the size of the rear seat 500 needs to be reduced to ensure space for the opening part 504 of the suction duct 502, thereby decreasing the functionality of the rear seat 500, and concomitantly, the utility of the vehicle.

The above information disclosed in this Background section is only for enhancement of understanding of the background of the invention.

### SUMMARY OF THE DISCLOSURE

The present invention has been made in an effort to provide a system and apparatus for cooling high voltage parts of a vehicle capable of improving the utility of the vehicle by maximizing the size and comfort of the rear seat while maintaining the ability to effectively supply cool air needed to cool the high voltage parts mounted in the vehicle. For example, the size and comfort of the rear seat is not reduced because unlike conventional art solutions, the suction duct is not incorporated into a separate ornamental trim member, or the like, disposed on the side of the rear seat.

In a preferred embodiment, a system and apparatus for cooling high voltage parts (HVP) includes high voltage part conduit to route cooling air from the interior of the vehicle to the HVP, with a first end configured to discharge cooling air onto the HVP, and a second end configured to receive cooling air from a rear seat conduit disposed within a rear seat. The rear seat conduit has an inlet and an outlet. Cooling air is routed into the rear seat conduit from the interior of the vehicle via the inlet. The cooling air flows through the rear seat conduit from the inlet to the outlet, which is configured to route cooling air into the second end of the high voltage part conduit. The second end of the high voltage part conduit may be removably connectable to the rear seat conduit via the rear seat conduit outlet.

### BRIEF DESCRIPTION OF THE DRAWINGS

The above and other features of the present invention will now be described in detail with reference to certain preferred embodiments thereof illustrated in the accompanying drawings which are given hereinbelow by way of illustration only, and thus are not limitative of the present invention, and wherein:

FIGS. 1 and 2 are diagrams showing a high voltage parts cooling structure of a vehicle according to the conventional art;

FIG. 3 is a diagram showing a system and apparatus for cooling high voltage parts of a vehicle according to an exemplary embodiment of the present invention;

FIG. 4 is a diagram showing a main structure of FIG. 3; and

FIG. 5 is a diagram showing a state in which a seat back is folded forward in the state of FIG. 4.

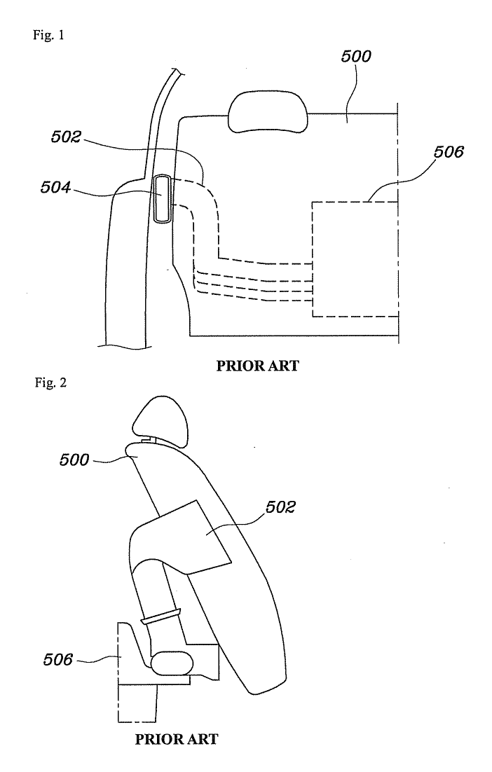

### DETAILED DESCRIPTION

Hereinafter reference will now be made in detail to various embodiments of the present invention, examples of which are illustrated in the accompanying drawings and described below. While the invention will be described in conjunction with preferred embodiments, it will be understood that the present description is not intended to limit the invention to those preferred embodiments. On the contrary, the invention is intended to cover not only the preferred embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

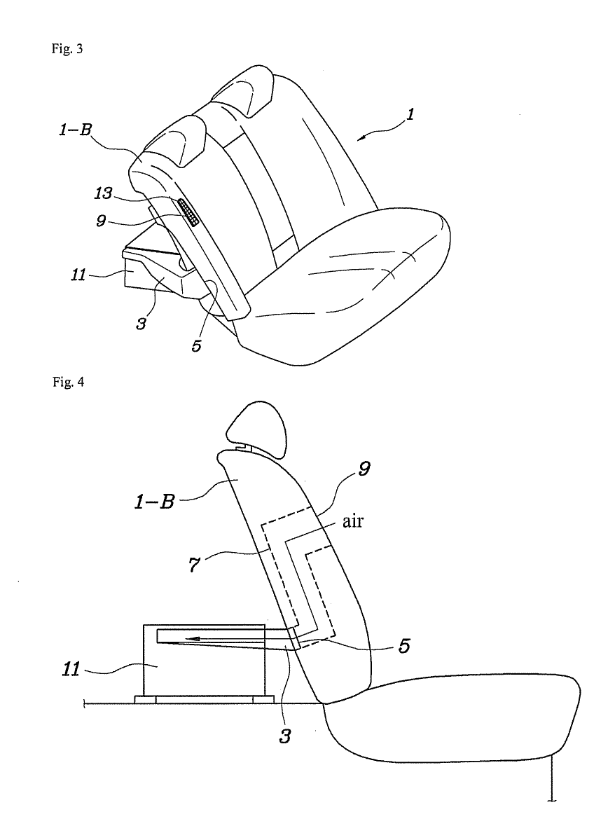

Referring to FIGS. 3, 4, and 5, a system and apparatus for cooling high voltage parts (HVP) of a vehicle according to an exemplary embodiment of the present invention includes a high voltage part conduit 3 to route cooling air from the interior of the vehicle to the HVP, with a first end configured to discharge cooling air onto the HVP, and a second end configured to receive cooling air from a rear seat conduit 7 disposed within a rear seat 1. The rear seat conduit 7 has a rear seat conduit inlet 9 and a rear seat conduit outlet 5. Cooling air is routed into the rear seat conduit 7 from the interior of the vehicle via the rear seat conduit inlet 9. The cooling air flows through the rear seat conduit 7, from the rear seat conduit inlet 9 to the rear seat conduit outlet 5, which is configured to route cooling air into the second end of the high voltage part conduit 3. The second end of the high voltage part conduit 3 may be removably connectable to the rear seat conduit 7 via the rear seat conduit outlet 5, and may be formed as a connectable formation or part. For example, the removably connectable portion of the high voltage part conduit 3 may be embodied as a moldable unibody part formed with the rear seat conduit, or as a separate detachable part fitted thereon.

Unlike the conventional art, in which the rear seat conduit protrudes from the side of the rear seat, the present invention disposes the rear seat conduit 7 within the rear seat 1 of the vehicle, such that the air in the interior of the vehicle may sequentially pass into the rear seat conduit inlet 9 through the rear seat conduit 7, out the rear seat conduit outlet 5, and into the high voltage part conduit 3, thereby supplying cooling air to the high voltage parts to be cooled.

Therefore, the present invention can sufficiently secure a width of the seat back of the rear seat 1 to a level capable of securing a comport of a passenger without needing to reduce a width of a seat back of the rear seat 1 to secure the side of the rear sheet 1 as in the related art so as to implement a comfortable feeling of sitting when a passenger is seated, thereby maximizing the size and comfort of the rear seat 1, while improving the utility of the vehicle.

In addition, since the high voltage part conduit 3 is disposed on the back side of the rear seat 1, the high voltage part conduit 3 is not visible from the outside from the interior of the vehicle. As a result, the separate ornamental trim member does not need to be used to hide the HVP conduit as in the conventional art and therefore, the cost of the vehicle may be reduced accordingly.

The high voltage part conduit 3 is configured to be removably connectable to the rear seat conduit outlet 5 on the rear surface of a seat back 1-B. For example, when the seat back 1-B of the rear seat 1 is folded down, high voltage part conduit 3 is not connected to rear seat conduit outlet 5, but when the seat back 1-B is in the upright position so that a passenger may be seated, the rear seat conduit 7 is configured so that the rear seat conduit inlet 9 is connected to the second end of the high voltage part conduit 3.

Therefore, the air sucked into the rear seat conduit inlet 9 of the rear seat conduit 7 from the front of the seat back 1-B is supplied to the high voltage part conduit 3 through the seat back 1-B and moves along the high voltage part conduit 3 to reach the high voltage part 11 to be cooled.

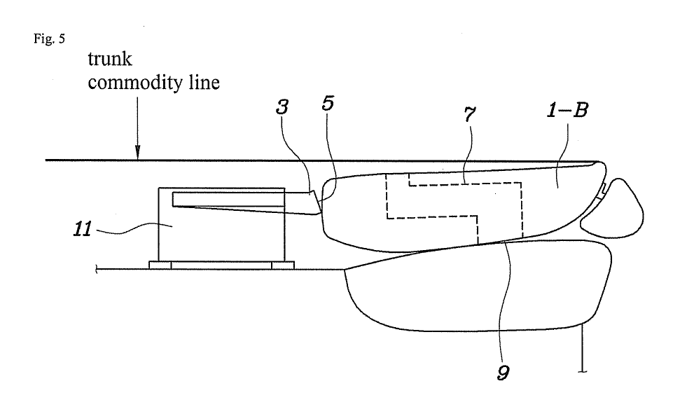

Meanwhile, the rear seat conduit outlet 5 of the high voltage part conduit 3 is mounted to be covered from the outside by a bottom surface of the seat back 1-B in a state in which the seat back 1-B of the rear seat 1 is folded forward, as shown in FIG. 5.

Therefore, when the seat back 1-B is folded, the rear seat conduit outlet 5 of the high voltage part conduit 3 may be not exposed to the outside so as to ensure that the rear seat 1 is aesthetically pleasing. Additionally, this configuration may prevent foreign materials from being introduced into the high voltage part conduit 3 from the outside.

In addition, a top surface of the high voltage part 11 connected to the high voltage part conduit 3 forms a plane of the same level as the rear surface of the seat back 1-B in a state in which the seat back 1-B of the rear seat 1 is folded forward and the high voltage part conduit 3 is disposed in a region under the same level of plane in which the rear surface of the seat back 1-B and the top surface of the high voltage part 11 are formed.

In this configuration, a representative example of the high voltage part 11 may include a high voltage battery. For example, when the seat back 1-B of the rear seat 1 is folded so that the rear surface of the seat back 1-B faces up, meeting a height of the top surface of the high voltage battery, the rear surface of the seat back 1-B forms the same level of plane as the top surface of the high voltage battery and the high voltage part conduit 3 is not protruding to a top side of the plane, so that a space without a protrusion may be generally secured in a region above the top surface of the high voltage battery.

This is to improve the utility of the trunk by ensuring the commodity line under the trunk room is formed on the top surface of the high voltage battery.

As shown in FIGS. 4 and 5, the high voltage part conduit 3 is formed in a shape horizontally extending along the top surface of the high voltage part 11 and therefore, it is preferable to align the top surface of the high voltage part 11, the top surface formed by the rear surface of the folded seat back 1-B, the rear surface of the folded seat back 1-B, and the top surface of the high voltage part conduit 3 within a single plane.

In one embodiment, the rear seat conduit inlet 9 of the rear seat conduit 7 is biased to one side of the seat back 1-B so that the rear seat conduit inlet 9 is mounted so as to be opened at a position of 2/3 or more of the entire length in a vertical direction from the bottom end of the seat back 1-B. This position corresponds to a location slightly higher than a shoulder of an adult, when an adult is seated in the rear seat 1. This is to prevent the rear seat conduit inlet 9 of the rear seat conduit 7 from being covered by a passenger.

The rear seat conduit inlet 9 of the rear seat conduit 7 is further provided with a grill 13 so as to prevent foreign materials from entering the rear seat conduit inlet 9 and prevent the inside of the rear seat conduit inlet 9 from being exposed.

The rear seat conduit 7 may be configured by a duct mounted to penetrate through the rear seat 1.

As set forth above, the exemplary embodiments of the present invention can improve the utility of the vehicle by ensuring the comfort of the rear seat while effectively supplying cooling air to the high voltage parts mounted in the vehicle without reducing the size or comfort of the rear seat, and reducing the cost of the vehicle by not using the separate ornamental trim member, or the like, as is the case in the conventional art.

In addition, the exemplary embodiments of the present invention can ensure the commodity line under the trunk room by forming the rear surface of the seat back so as to have a predetermined level, in the same plane as the high voltage parts and the high voltage part conduit when the seat back of the rear seat is folded forward, thereby improving the utility of the trunk.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for cooling high voltage parts (HVP) of a vehicle, comprising:
a rear seat conduit having an inlet and an outlet, wherein the rear seat conduit is disposed within a rear seat of the vehicle, and is configured to receive cooling air from an interior of the vehicle into the inlet, route the cooling air through the rear seat conduit, and out the outlet; and
a high voltage part conduit having a first end and a second end, wherein the second end is configured to receive cooling air from the rear seat conduit outlet, and the first end is configured to discharge cooling air onto the HVP.

2. The apparatus of claim 1, wherein the rear seat conduit outlet is disposed on the rear surface of the rear seat, and the rear seat conduit inlet is disposed on the front surface of the rear seat.

3. The apparatus of claim 1, wherein the second end of the high voltage part conduit is removably connectable to the rear seat conduit outlet.

4. The apparatus of claim 1, wherein the rear seat conduit outlet is configured so as to be covered from the outside by a bottom surface of the seat back when the seat back of the rear seat is folded forward.

5. The apparatus of claim 1, wherein a top surface of the high voltage part connected to the high voltage part conduit forms a plane with the same level as the rear surface of the seat back in a state in which the seat back of the rear seat is folded forward; and
the high voltage part conduit is disposed in a region under the same level of plane in which the rear surface of the seat back and the top surface of the high voltage part are formed.

6. The apparatus of claim 1, wherein the rear seat conduit inlet of the rear seat conduit is biased to one side of the seat back so that the rear seat conduit inlet is mounted to be opened at a position of 2/3 or more of the entire length in a vertical direction from the bottom end of the seat back.

7. The apparatus of claim 6, wherein the rear seat conduit inlet is biased to a side of the rear seat back closest to an exterior side of the vehicle.

8. The apparatus of claim 1, wherein the rear seat conduit inlet of the rear seat conduit further includes a grill to prevent foreign materials from entering the rear seat conduit inlet.

9. The high voltage parts cooling structure of claim 1, wherein the rear seat conduit is configured as a duct mounted to penetrate through the rear seat.
